(19) United States
(12) Patent Application Publication
(10) Pub. No.: US 2026/0298813 A1
(43) Pub. Date: Oct. 1, 2026

(54) ATOMIC ABSORPTION SPECTROPHOTOMETER

(71) Applicant: SHIMADZU CORPORATION, Kyoto-shi (JP)

(72) Inventors: Naoya FUJIWARA, Kyoto-shi (JP); Kazuo SUGIHARA, Kyoto-shi (JP); Koichi SAWADA, Kyoto-shi (JP)

(73) Assignee: SHIMADZU CORPORATION, Kyoto-shi (JP)

(21) Appl. No.: 19/570,583

(22) Filed: Mar. 18, 2026

(30) Foreign Application Priority Data
Apr. 1, 2025 (JP) 2025-060319

(51) Int. Cl. G01N 21/31; G01N 21/17

(52) U.S. Cl. CPC G01N 21/3103; G01N 21/1717; G01N 2021/1731

(57) ABSTRACT

An atomic absorption spectrophotometer having: an absorbance measurement unit configured to measure absorbance by passing measurement light through a predetermined space; an atomization unit configured to generate atomic vapor in the space by heating a measurement target sample; a sample introduction unit configured to introduce the measurement target sample into the atomization unit; and a display control unit configured to display, on a screen of a display device in real time, a graph (611) representing a temporal change in absorbance measured by the absorbance measurement unit over a period from a start to an end of a series of analyses in which each of a plurality of samples is used as the measurement target sample, and to superimposedly display, on the graph, a sample mark (615) that is a mark corresponding to each of the plurality of samples at a position corresponding to a measurement timing of each of the plurality of samples.

### TECHNICAL FIELD

The present invention relates to an atomic absorption spectrophotometer.

### BACKGROUND ART

An atomic absorption spectrophotometer is an apparatus that measures the concentration of a specific element in a sample by heating the sample to atomize it and measuring the absorption of light by the atoms. When analyzing a plurality of samples using such an atomic absorption spectrophotometer, a sample table describing what samples are to be measured and in what order is registered in advance by a user. Thereafter, according to the description in the sample table, each of the plurality of samples is sequentially introduced into an atomization unit, and absorbance values in a predetermined time range after the introduction of each sample into the atomization unit are acquired as measurement data. Then, the concentration of the measurement target element in each sample is determined based on the measurement data acquired for each sample.

Some conventional atomic absorption spectrophotometers are equipped with a function to display not only the measurement data acquisition period as described above (i.e., the predetermined time range after the introduction of each sample into the atomization unit) but also a graph representing absorbance changes in real time from the start to the end of a series of measurements registered in the sample table (hereinafter referred to as a real-time graph) (see, for example, Non-Patent Literature 1). By referring to such a real-time graph, the user can grasp the overall trend of absorbance in the series of measurements (e.g., fluctuation of the baseline) or check for abnormal data by comparing the peak of each sample with the peaks of the preceding and succeeding samples.

### CITATION LIST

### Non-Patent Literature

[Non-Patent Literature 1] “AA-7800 Series-Features”, [online], Shimadzu Corporation, [Searched on April 1, 2025], Internet <URL: https://www.an.shimadzu.co.jp/products/elemental-analysis/atomic-absorption-spectroscopy/aa-7800/features.html>

### SUMMARY OF INVENTION

### Technical Problem

In an atomic absorption spectrophotometer equipped with a real-time graph display function as described above, when the measurement time becomes long, such as when analyzing a large number of samples, the real-time graph becomes longer accordingly. Therefore, some conventional atomic absorption spectrophotometers automatically delete absorbance data for real-time graph generation in order from the oldest and display only the data of the most recent predetermined time range as a real-time graph. However, in this case, data older than the most recent predetermined time range cannot be referred to.

Therefore, there is a system in which all absorbance data for real-time graph generation is stored without deletion, and a user can display a graph of a desired time range by performing a scroll operation on the real-time graph. However, since a plurality of peaks corresponding to a plurality of samples are arranged in the real-time graph, and each peak has a similar shape, there is a problem that it is difficult for the user to grasp which sample the currently displayed peak corresponds to when the user performs the scroll operation.

The present invention has been made in view of the above points, and an object thereof is to enable a user to easily grasp the correspondence between a peak on a real-time graph and each of a plurality of samples when continuously analyzing the plurality of samples in an atomic absorption spectrophotometer.

### Solution to Problem

An atomic absorption spectrophotometer according to the present invention made to solve the above problem comprises:
an absorbance measurement unit configured to measure absorbance by passing measurement light through a predetermined space;
an atomization unit configured to generate atomic vapor derived from a measurement target sample in the predetermined space by heating the measurement target sample;
a sample introduction unit configured to introduce the measurement target sample into the atomization unit; and
a display control unit configured to display, on a screen of a display device in real time,
a graph representing a temporal change in absorbance measured by the absorbance measurement unit over a period from a start to an end of a series of analyses in which each of a plurality of samples is used as the measurement target sample, and to superimposedly display, on the graph, a sample mark that is a mark corresponding to each of the plurality of samples at a position corresponding to a measurement timing of each of the plurality of samples.

### Advantageous Effects of Invention

According to the atomic absorption spectrophotometer according to the present invention having the above configuration, when continuously analyzing a plurality of samples, a user can easily grasp the correspondence relationship between a peak on a real-time graph and each of the plurality of samples.

### BRIEF DESCRIPTION OF DRAWINGS

FIG. 1 is a schematic configuration diagram of an atomic absorption spectrophotometer according to an embodiment of the present invention.

FIG. 2 is a flowchart showing the operation of the atomic absorption spectrophotometer.

FIG. 3 is a diagram showing an initial state of a measurement screen in the atomic absorption spectrophotometer.

FIG. 4 is a diagram showing a state in which sample information is input to a sample table in the measurement screen.

FIG. 5 is a diagram showing a state in which drawing of a graph is started in a real-time graph display area of the measurement screen.

FIG. 6 is a diagram showing a state in which an operation mark is attached to the graph.

FIG. 7 is a diagram showing a state in which a sample mark is further attached to the graph.

FIG. 8 is a diagram showing a state in which a measurement period mark is further attached to the graph.

FIG. 9 is a diagram showing an example of a screen display when a sample mark attached to the graph is selected on the measurement screen.

FIG. 10 is a diagram showing another example of a screen display when a sample mark attached to the graph is selected on the measurement screen.

FIG. 11 is a diagram showing a state in which a sample mark is selected from a pull-down menu on the measurement screen.

FIG. 12 is a diagram showing a display state of the graph after a sample mark is selected in the pull-down menu.

### DESCRIPTION OF EMBODIMENTS

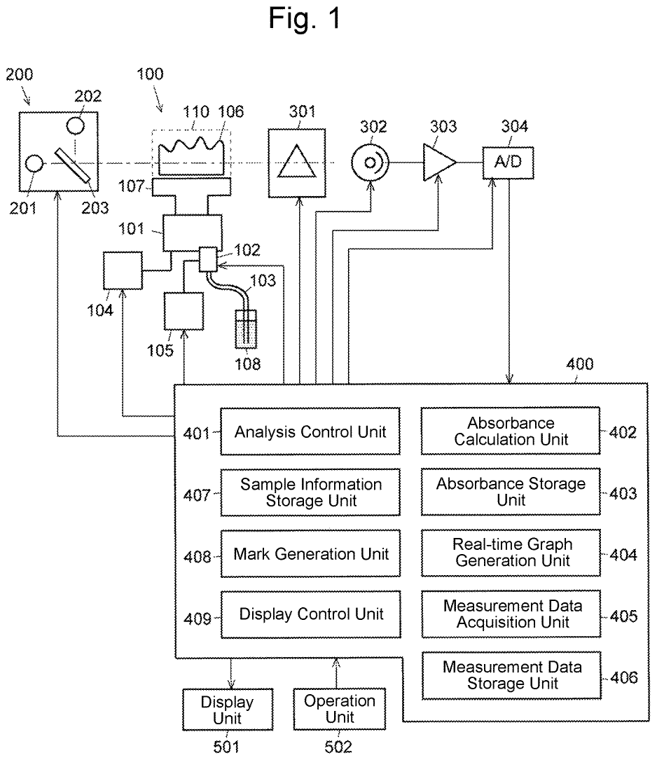

Hereinafter, embodiments for carrying out the present invention will be described with reference to the drawings. FIG. 1 is a schematic configuration diagram of an atomic absorption spectrophotometer according to the present embodiment. This atomic absorption spectrophotometer includes an atomization unit 100 that atomizes a sample, a light source unit 200 that emits light toward the atomized sample, a spectroscopic unit 301 that disperses light that has undergone absorption by atoms, a photodetector 302 that detects light of a predetermined wavelength obtained by the spectroscopic unit 301, an amplifier 303 that amplifies an output signal from the photodetector 302, an A/D converter 304 that converts an output signal from the amplifier 303 into digital data, and a control/processing unit 400 that controls each of the units and processes the digital data.

The atomization unit 100 includes a chamber 101, a nebulizer 102 that atomizes a sample liquid, a sample suction tube 103 connected to the nebulizer 102, a fuel gas supply unit 104 that supplies a fuel gas (for example, acetylene) into the chamber 101, a combustion support gas supply unit 105 that supplies a combustion support gas (for example, air or nitrous oxide) to the nebulizer 102, and a burner head 107 that forms a flame 106 by blowing upward and burning the atomized sample liquid, the fuel gas, and the combustion support gas mixed in the chamber 101.

The combustion support gas plays a role of assisting combustion and also acts as a nebulizing gas for spraying the sample liquid. That is, when the combustion support gas is supplied from the combustion support gas supply unit 105 to the nebulizer 102 in a state where the tip of the sample suction tube 103 is inserted into a sample container 108, the combustion support gas is ejected into the chamber 101, and the sample liquid in the sample container 108 is sucked up to the nebulizer 102 through the sample suction tube 103 by the negative pressure generated thereby, and is sprayed into the chamber 101. That is, the combustion support gas supply unit 105, the nebulizer 102, and the sample suction tube 103 in the present embodiment correspond to the sample introduction unit in the present invention.

The light source unit 200 includes a measurement light source 201 (for example, a hollow cathode lamp) that emits measurement light including an emission line spectrum of a measurement target element, a correction light source 202 (for example, a deuterium lamp) that emits light including a continuous spectrum (continuous light) for background correction, and a half mirror 203. The measurement light emitted from the measurement light source 201 passes through the half mirror 203 and enters a space above the burner head 107 (hereinafter referred to as an atomization space 110). Note that this atomization space 110 corresponds to the predetermined space in the present invention. On the other hand, the continuous light emitted from the correction light source 202 is reflected by the half mirror 203 and enters the atomization space 110 coaxially with the measurement light. The measurement light source 201 and the correction light source 202 are configured to be pulse-lit alternately, and the measurement light from the measurement light source 201 and the continuous light from the correction light source 202 pass through the atomization space 110 and the spectroscopic unit 301 and are alternately detected by the photodetector 302, and a time-division multiplexed (TDM) signal is output from the photodetector 302.

The control/processing unit 400 includes, as functional blocks, an analysis control unit 401, an absorbance calculation unit 402, a real-time graph generation unit 404, a measurement data acquisition unit 405, a mark generation unit 408, and a display control unit 409. Furthermore, the control/processing unit 400 includes an absorbance storage unit 403, a measurement data storage unit 406, and a sample information storage unit 407.

The entity of the control/processing unit 400 is a computer such as a personal computer equipped with a CPU, a memory, and a large-capacity storage device (HDD or SSD, etc.), and the functions of the respective functional blocks described above are realized by executing a predetermined program pre-installed in the computer by the CPU. Further, the absorbance storage unit 403, the measurement data storage unit 406, and the sample information storage unit 407 are provided in the large-capacity storage device provided in the computer. A display unit 501 including a liquid crystal display or the like, and an operation unit 502 including a pointing device such as a mouse, a keyboard, or predetermined operation buttons or the like are connected to the computer constituting the control/processing unit 400.

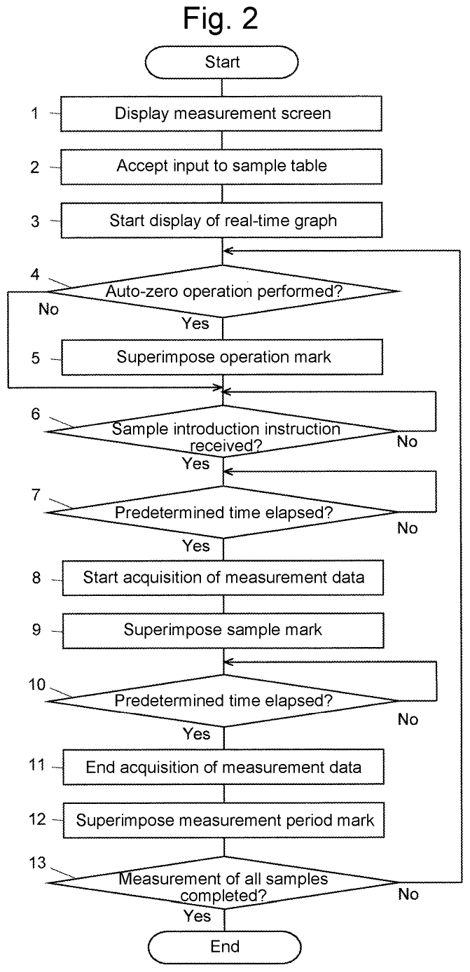

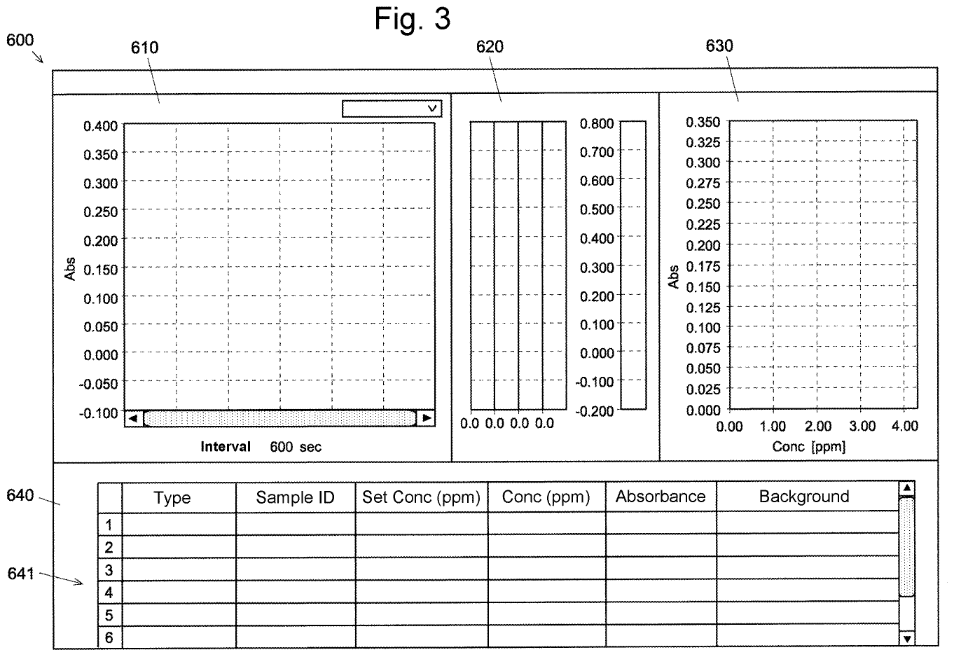

The operation of the atomic absorption spectrophotometer according to the present embodiment will be described with reference to the flowchart of FIG. 2. First, the user instructs the control/processing unit 400 to display a measurement screen 600 by performing a predetermined operation on the operation unit 502. Thereby, under the control of the display control unit 409, a measurement screen 600 as shown in FIG. 3 is displayed on the screen of the display unit 501 (Step 1). This measurement screen 600 includes a real-time graph display area 610, a measurement profile display area 620, a calibration curve display area 630, and a sample table display area 640. Note that the measurement profile display area 620 is an area where measurement data acquired by the measurement data acquisition unit 405 described later is displayed, and the calibration curve display area 630 is an area where a calibration curve created by measurement of a standard sample described later is displayed, but since they are not directly related to the present invention, detailed description thereof is omitted.

Regarding the analysis of a plurality of samples to be executed (hereinafter referred to as a series of analyses), the user inputs information on each sample into a sample table 641 in the sample table display area 640 via the operation unit 502 (Step 2). Here, as the series of analyses, a case where three standard samples containing a measurement target element at different concentrations and five unknown samples whose concentrations of the measurement target element are unknown are measured will be described as an example.

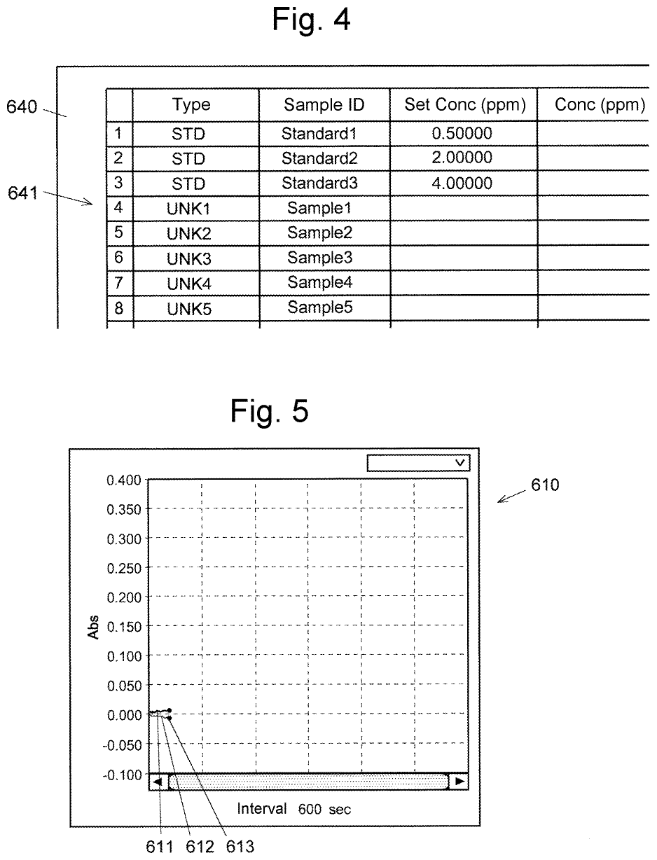

FIG. 4 shows an example of input to the sample table 641 in Step 2. In the figure, illustration of areas other than the sample table display area 640 among the respective areas included in the measurement screen 600 is omitted for simplification. The sample table 641 is a table in which what samples are analyzed in what order is described, and each row corresponds to one sample. An analysis number indicating the execution order of analysis is described in advance in the first column of each row. In addition, the type of sample can be input in the second column of each row, a sample ID in the third column, and a set concentration in the fourth column. Here, the type of sample is a distinction as to whether the sample is a standard sample (STD) or an unknown sample (UNK), and the sample ID is an identifier unique to each sample. As the set concentration, the concentration (known) of the measurement target element contained in each standard sample is entered. Note that in the fourth column and the fifth column of each row, after the measurement of each sample is executed, the concentration and absorbance of the sample determined by the measurement are automatically input, respectively. The contents input to the sample table 641 as described above are stored in the sample information storage unit 407.

Subsequently, the user instructs ignition of the burner head 107 of the atomization unit 100 via the operation unit 502. Thereby, under the control of the analysis control unit 401, the fuel gas and the combustion support gas are supplied from the fuel gas supply unit 104 and the combustion support gas supply unit 105 to the chamber 101, and these gases (mixed gas) mixed in the chamber 101 are ejected from the burner head 107. Then, by igniting the mixed gas by an ignition mechanism (not shown), the mixed gas is burned, and the flame 106 is formed in the atomization space 110.

Subsequently, the user instructs lighting of the light source unit 200 via the operation unit 502. Thereby, pulse lighting of the measurement light source 201 and the correction light source 202 is started, and light from these light sources 201 and 202 is alternately emitted from the light source unit 200. These lights passing through the atomization unit 100 pass through the spectroscopic unit 301 and are received by the photodetector 302. The photodetector 302 outputs a detection signal corresponding to the intensity of the received light, and the detection signal is amplified by the amplifier 303. The A/D converter 304 samples the detection signal amplified by the amplifier 303 at a predetermined sampling period (hereinafter referred to as a first sampling period) and converts it into a digital signal. Note that in the signal output from the amplifier 303, a signal derived from light (measurement light) from the measurement light source 201 and a signal derived from light (continuous light) from the correction light source 202 appear alternately. Therefore, the A/D converter 304 separates both by performing sampling synchronized with the lighting period of each of the light sources 201 and 202.

Note that the ignition of the burner head 107 and the lighting of the light sources 201 and 202 as described above may be performed before Step 1 or before Step 2.

Subsequently, when the user inputs via the operation unit 502 that the series of analyses is to be started, drawing of a graph by the real-time graph generation unit 404 is started (Step 3). That is, the digital signal derived from the measurement light and the digital signal derived from the continuous light, which are separated and sampled by the A/D converter 304, are respectively taken into the absorbance calculation unit 402. The absorbance calculation unit 402 holds a relational expression indicating the relationship between signal intensity and absorbance, and calculates the absorbance of the measurement light and the absorbance of the continuous light from the intensity of the digital signal derived from the measurement light and the intensity of the digital signal derived from the continuous light, respectively. That is, in the present invention, the light source unit 200, the spectroscopic unit 301, the photodetector 302, the amplifier 303, the A/D converter 304, and the absorbance calculation unit 402 cooperate to function as the absorbance measurement unit in the present invention.

The absorbance of the measurement light and the absorbance of the continuous light sequentially output from the absorbance calculation unit 402 are respectively stored in the absorbance storage unit 403 and sent to the real-time graph generation unit 404. By plotting the absorbance of the measurement light and the absorbance of the continuous light against time, respectively, the real-time graph generation unit 404 generates a graph indicating a temporal change in absorption of the measurement light by the atomization space 110 and a graph indicating a temporal change in absorption of the continuous light (i.e., background absorption) by the atomization space 10 [sic]. These graphs generated by the real-time graph generation unit 404 are displayed in the real-time graph display area 610 of the measurement screen 600 under the control of the display control unit 409.

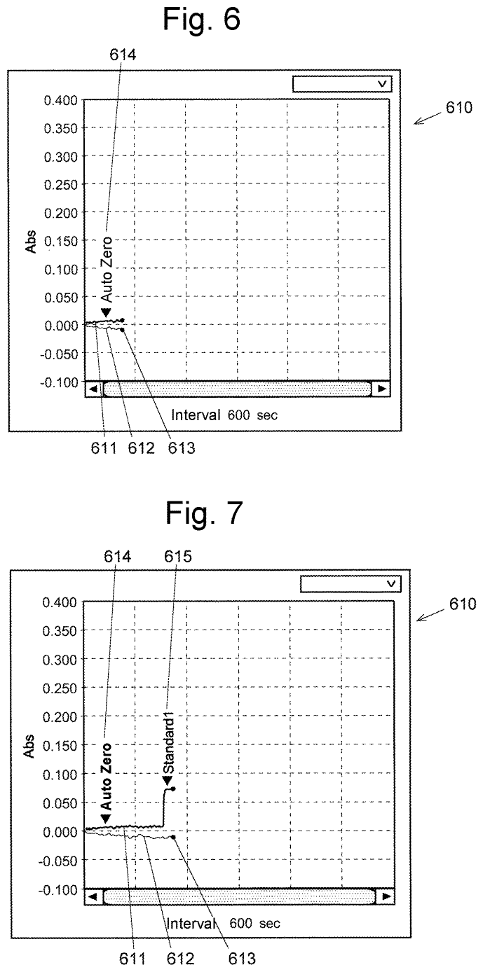

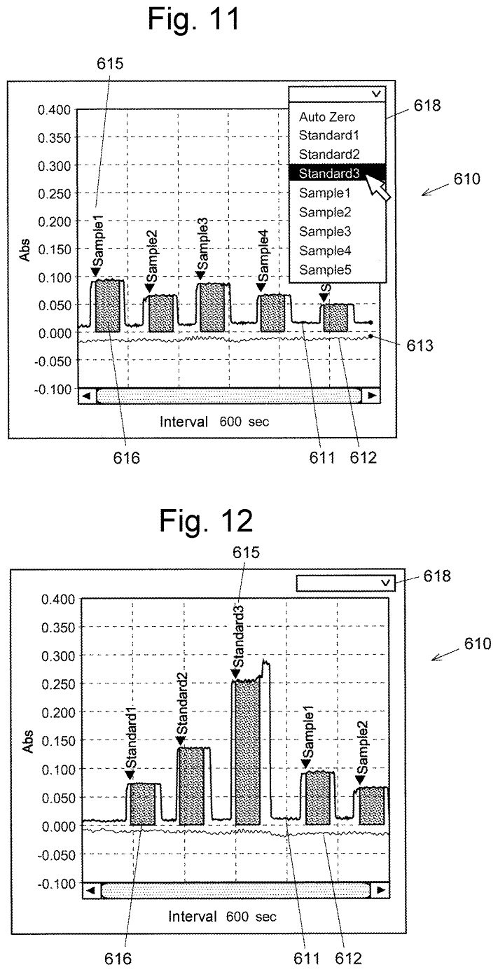

An example of the screen display at this time is shown in FIG. 5. Note that in the figure, illustration of areas other than the real-time graph display area 610 among the respective areas included in the measurement screen 600 is omitted for simplification (the same applies to FIG. 6 to FIG. 9, FIG. 11, and FIG. 12 described later). In the figure, a graph showing the temporal change in absorption of the measurement light in real time (hereinafter simply referred to as a real-time graph 611) is represented by a thick line, and a graph showing the temporal change in the background absorption in real time (hereinafter referred to as a background graph 612) is represented by a thin line, but these may be displayed in different colors. These graphs 611 and 612 displayed in the real-time graph display area 610 are updated every time a new absorbance value is output from the absorbance calculation unit 402 along with sampling by the A/D converter 304. In FIG. 5, a point 613 attached to the right end of each of the graphs 611 and 612 represents the absorbance value at that time (i.e., the latest), and the position of this point 613 moves to the right in the real-time graph display area 610 every time each of the graphs 611 and 612 is updated. Then, when these points 613 reach the right end of the real-time graph display area 610, the graphs 611 and 612 are automatically scrolled along the time axis. Thereby, even if a long time has elapsed since the start of the series of analyses, the point 613 can always be displayed in the real-time graph display area 610.

After the generation and display of the real-time graph 611 (and the background graph 612) as described above are started, if an execution instruction for an auto-zero operation is input by the user from the operation unit 502 (that is, if Yes in Step 4 of FIG. 2), the relational expression in the absorbance calculation unit 402 is calibrated so that the absorbance value at that time becomes 0. Note that at this time, the operation unit 502 corresponds to the instruction reception unit in the present invention. Furthermore, a graphic indicating that the auto-zero operation has been performed (hereinafter referred to as an operation mark 614) is generated by the mark generation unit 408, and under the control of the display control unit 409, is superimposedly displayed on the real-time graph 611 at a position corresponding to the time when the auto-zero operation was executed (Step 5).

FIG. 6 shows a state in which such an operation mark 614 is superimposedly displayed on the real-time graph 611 of the measurement screen 600. In the figure, the operation mark 614 is composed of a character string “Auto Zero” and an arrowhead indicating the execution time of the auto-zero operation, but the operation mark 614 is not limited to this, and may be anything as long as it includes at least an identifier indicating the operation content (a character string such as an operation name, or a symbol, etc.).

Note that if the execution instruction for the auto-zero operation by the user is not input after Step 3 (that is, if Step 4 in FIG. 2 is No), the process proceeds to Step 6 described later without performing the auto-zero operation and the attachment of the operation mark 614 as described above.

When the user inserts the tip of the sample suction tube 103 into the sample container 108 containing the first sample on the sample table 641 (that is, the sample described in the first row of the sample table 641) and instructs introduction of the sample into the atomization unit 100 by performing a predetermined operation on the operation unit 502 (that is, when Step 6 in FIG. 2 becomes Yes), a predetermined amount of sample liquid is sucked from the sample container 108 into the sample suction tube 103 under the control of the analysis control unit 401. The sucked sample liquid is sprayed into the chamber 101 by the nebulizer 102, mixed with the combustion support gas and the fuel gas in the chamber 101, and then introduced into the flame 106. Thereby, the sample is heated and atomized, and atomic vapor derived from the sample is generated in the atomization space 110.

When a predetermined time (for example, 2 to 5 seconds) elapses after the instruction for sample introduction by the user is made (that is, when Step 7 in FIG. 2 becomes Yes), acquisition of measurement data by the measurement data acquisition unit 405 is started (Step 8). Here, acquisition of measurement data means changing the sampling period in the A/D converter 304 to a second sampling period shorter than the first sampling period described above, and taking into the measurement data storage unit 406 and storing the value of the absorbance of the measurement light and the value of the absorbance of the continuous light sequentially calculated by the absorbance calculation unit 402 based on the digital signal sampled at the second sampling period.

Note that the absorbance values output from the absorbance calculation unit 402 during acquisition of measurement data are sent not only to the measurement data storage unit 406 but also to the absorbance storage unit 403 and the real-time graph generation unit 404. Therefore, even while measurement data is being acquired, the real-time graph 611 and the background graph 612 displayed in the real-time graph display area 610 are updated on the measurement screen 600.

Subsequently, a graphic representing the introduced sample (hereinafter referred to as a sample mark 615) is generated by the mark generation unit 408, and under the control of the display control unit 409, is superimposedly displayed on the real-time graph 611 at a position corresponding to the time when acquisition of the measurement data was started (or the time when introduction of the sample into the atomization unit 100 was started) (Step 9).

FIG. 7 shows a state in which such a sample mark 615 is superimposedly displayed on the real-time graph 611. In the figure, the sample mark 615 is composed of a character string “Standard1” and an arrowhead indicating the time when acquisition of measurement data for the sample started, but is not limited to this, and the sample mark 615 may be anything as long as it includes at least an identifier unique to the sample (for example, the sample ID or analysis number described in the sample table 641). Note that the identifier is specified by the mark generation unit 408 referring to the information of the sample stored in the sample information storage unit 407.

Thereafter, when a predetermined time (for example, 2 to 5 seconds) elapses from the start of measurement data acquisition (that is, when Step 10 in FIG. 2 becomes Yes), acquisition of measurement data by the measurement data acquisition unit 405 ends (Step 11). That is, the sampling period in the A/D converter 304 is returned from the second sampling period to the first sampling period, and the intake of absorbance values into the measurement data storage unit 406 is stopped.

Subsequently, a graphic indicating the measurement period of the sample (that is, the period from the start of acquisition to the end of acquisition of measurement data related to the sample) (hereinafter referred to as a measurement period mark 616) is generated by the mark generation unit 408, and under the control of the display control unit 409, is superimposedly displayed on the real-time graph 611 at a position corresponding to the measurement period (Step 12).

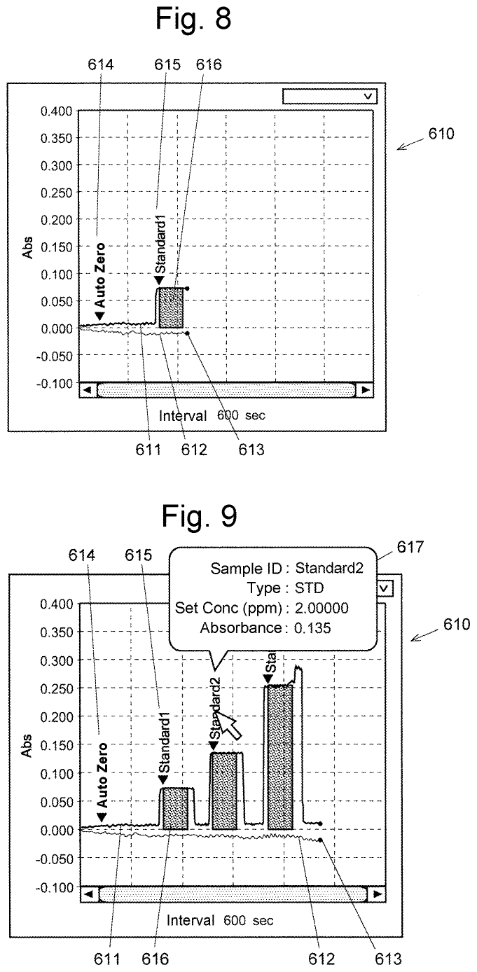

FIG. 8 shows a state in which such a measurement period mark 616 is superimposedly displayed on the real-time graph 611. In the figure, the measurement period mark 616 is a filled portion corresponding to the measurement period within the area inside the peak corresponding to the sample in the real-time graph 611, but the measurement period mark 616 may be anything as long as it indicates the acquisition start time of the measurement data and the acquisition end time of the measurement data, and may be, for example, a straight line or an arrow extending in the horizontal direction (time axis direction) having the acquisition start time as a starting point and the acquisition end time as an ending point. Alternatively, a color (or shading) different from that of other time ranges may be applied to the background of the real-time graph 611 only for the time range from the acquisition start time to the recording end time, or the color (or thickness) of the line constituting the real-time graph 611 may be made different from that of other time ranges only for the time range.

Thereafter, the process returns to Step 4, and Steps 4 to 12 are repeatedly executed until measurement of all samples described in the sample table 641 is completed (that is, until Step 13 in FIG. 2 becomes Yes).

As described above, in the atomic absorption spectrophotometer according to the present embodiment, since the sample mark 615 is automatically attached onto the real-time graph 611, the user can easily grasp the correspondence relationship between each peak on the real-time graph 611 and each of the plurality of samples included in the series of analyses. In addition, by attaching the measurement period mark 616 in addition to the sample mark 615, the user can grasp at a glance the acquisition period of measurement data related to the sample corresponding to the sample mark 615. Furthermore, by performing the attachment of the operation mark 614 as described above, when a characteristic absorbance change is seen on the real-time graph 611, the user can easily determine whether the absorbance change is a result of an operation intentionally performed by the user (here, the auto-zero operation) or is caused by some error.

Furthermore, in the atomic absorption spectrophotometer according to the present embodiment, in the middle of the series of analyses or after the completion of the series of analyses, by selecting the sample mark 615 or the measurement period mark 616 attached to the real-time graph 611 via the operation unit 502, the user can cause information regarding the sample corresponding to the mark to be popup-displayed in the vicinity of the mark. In this case, the display unit 501, the display control unit 409, and the operation unit 502 correspond to the sample mark selection reception unit or the measurement period mark selection reception unit in the present invention.

An example of such a popup display is shown in FIG. 9. In the example of the figure, one operation mark 614, three sample marks 615, and three measurement period marks 616 are attached onto the real-time graph 611. In this state, when the user selects any sample mark 615 or measurement period mark 616 by, for example, a click operation via the operation unit 502, the display control unit 409 extracts information regarding the sample corresponding to the selected mark (hereinafter referred to as a selected mark) from the sample information storage unit 407, and displays a popup screen 617 describing the extracted information in the vicinity of the selected mark (the sample mark 615 of “Standard2” in the example of FIG. 9). Thereby, the user can easily refer to the information of the sample corresponding to the selected mark.

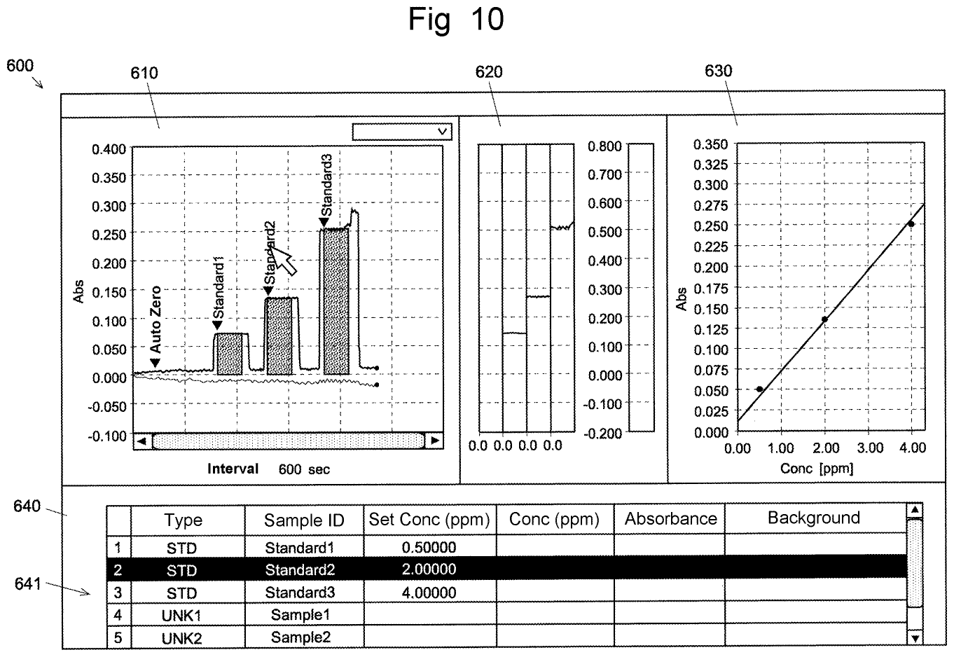

Note that instead of the popup display as described above, a row related to the sample corresponding to the selected mark may be highlighted on the sample table 641. A display example of the measurement screen 600 in such a case is shown in FIG. 10. In the example of the figure, one sample mark 615 (specifically, the sample mark of “Standard2”) is selected in the real-time graph display area 610, and in response to this, the row corresponding to the sample mark 615 is reversely displayed in the sample table 641 in the sample table display area 640. Thereby, the user can easily grasp the correspondence relationship between each peak on the real-time graph 611 and the sample described in each row of the sample table 641.

Note that the highlight display is not limited to the reverse display as described above, and for example, shading or coloring may be applied to the corresponding row, or the color or font of characters described in the row may be made different from other rows. Further, a predetermined mark (arrow, asterisk, etc.) may be attached to the row.

Furthermore, conversely to the above, by the user selecting a predetermined row on the sample table 641, the sample mark 615 or the measurement period mark 616 corresponding to the selected row among those attached to the real-time graph 611 may be highlighted. Here, as the highlight display, for example, applying shading or coloring to the corresponding sample mark 615 or measurement period mark 616, or making the color or font of characters included in the mark different from other marks can be considered. Further, it is also conceivable to further attach a predetermined mark (arrow, asterisk, etc.) to the mark.

Further, in the atomic absorption spectrophotometer according to the present embodiment, as shown in FIG. 11, a pull-down menu 618 is provided on the measurement screen 600. In this pull-down menu, a list of identifiers of the operation marks 614 and sample marks 615 currently attached on the real-time graph 611 is displayed. When the user selects an identifier of any operation mark or sample mark in this pull-down menu 618 via the operation unit 502, the real-time graph 611 (and the background graph 612) is automatically scrolled so that the position (time) where the mark selected in the pull-down menu 618 is attached comes to a predetermined position (for example, the center, left end, or right end) in the real-time graph display area 610. In this case, the display unit 501, the display control unit 409, and the operation unit 502 correspond to the second sample mark selection reception unit or the operation mark selection reception unit in the present invention. The example of FIG. 11 shows a state in which the auto-zero operation, measurement of three standard samples, and measurement of five unknown samples have been completed in a series of analyses. At this time, the portion of the real-time graph 611 corresponding to the time when the sample label “Standard3” was attached has already framed out to the left of the real-time graph display area 610. In this state, when “Standard3”, which is one of the sample marks 615 related to the standard sample, is selected from the pull-down menu 618, the real-time graph 611 (and the background graph 612) is automatically scrolled to the right under the control of the display control unit 409, and as shown in FIG. 12, the position where the sample mark 615 of “Standard3” is attached in the real-time graph 611 is displayed in the center of the real-time graph display area 610. Thereby, even when a long time has elapsed since the start of the series of analyses and the real-time graph 611 has become long, the user can easily refer to the place where the predetermined sample mark 615 or operation mark 614 is attached in the graph.

Note that in addition to such automatic scrolling, among the operation marks 614 or sample marks 615 attached on the real-time graph 611, the one corresponding to the mark name selected in the pull-down menu 618 may be highlighted.

As described above, embodiments for carrying out the present invention have been described with specific examples, but the present invention is not limited to the above embodiments, and appropriate modifications are allowed within the scope of the gist of the present invention. For example, in the above embodiment, when the auto-zero operation is performed, an operation label indicating that fact is attached to the real-time graph 611. However, the present invention is not limited to the auto-zero operation, and when another predetermined operation (particularly, one that affects the absorbance value) is performed, an operation label indicating the content of the operation may be attached to the real-time graph 611 at a position corresponding to the time when the operation was performed. Examples of the other predetermined operation include, but are not limited to, a rinse operation (operation of washing the flow path) or a line search operation (operation of adjusting the spectroscopic unit 301 so that the emission line is measured with the strongest intensity).

In the above embodiment, the atomic absorption spectrophotometer according to the present invention is a flame type atomic absorption spectrophotometer that atomizes a sample by a flame of a burner, but is not limited to this, and may be a flameless type (furnace type) atomic absorption spectrophotometer that heats a sample in an electric furnace to atomize it.

In the above embodiment, the user manually inserts the sample suction tube 103 into the sample container 108 and performs a predetermined operation on the operation unit 502 to instruct introduction of the sample into the atomization unit 100. However, the present invention is not limited to this, and a configuration may be adopted that includes an autosampler that holds a plurality of sample containers, automatically sequentially collects sample liquids in the plurality of containers, and feeds them to the atomization unit 100.

In the above embodiment, acquisition of measurement data is automatically started when a predetermined time has elapsed after the start of introduction of the sample into the atomization unit 100. However, instead of this, the user may instruct the start of acquisition of measurement data via the operation unit 502. Alternatively, the control/processing unit 400 may automatically determine the measurement data acquisition start timing based on the waveform of the real-time graph 611.

### Aspects

It will be apparent to those skilled in the art that the above-described exemplary embodiments are specific examples of the following aspects.

(Item 1) An atomic absorption spectrophotometer according to one aspect of the present invention comprises:
an absorbance measurement unit configured to measure absorbance by passing measurement light through a predetermined space;
an atomization unit configured to generate atomic vapor derived from a measurement target sample in the predetermined space by heating the measurement target sample;
a sample introduction unit configured to introduce the measurement target sample into the atomization unit; and
a display control unit configured to display, on a screen of a display device in real time,
a graph representing a temporal change in absorbance measured by the absorbance measurement unit over a period from a start to an end of a series of analyses in which each of a plurality of samples is used as the measurement target sample, and to superimposedly display, on the graph, a sample mark that is a mark corresponding to each of the plurality of samples at a position corresponding to a measurement timing of each of the plurality of samples.

(Item 2) The atomic absorption spectrophotometer according to Item 2 is the atomic absorption spectrophotometer according to Item 1,
further comprising a measurement data acquisition unit configured to acquire absorbance measured by the absorbance measurement unit over a predetermined time range after introduction of the measurement target sample into the atomization unit by the sample introduction unit as measurement data for the measurement target sample,
wherein the display control unit further superimposedly displays, on the graph, a measurement period mark that is a mark representing an acquisition period of the measurement data for each of the plurality of samples.

(Item 3) The atomic absorption spectrophotometer according to Item 3 is the atomic absorption spectrophotometer according to Item 1 or Item 2,
further comprising an instruction reception unit configured to receive an instruction from a user,
wherein, when an execution instruction for a predetermined operation is received by the instruction reception unit during a period from the start to the end of the series of analyses,
the display control unit further superimposedly displays, on the graph, an operation mark that is a mark corresponding to the predetermined operation at a position corresponding to an execution timing of the predetermined operation.

(Item 4) The atomic absorption spectrophotometer according to Item 4 is the atomic absorption spectrophotometer according to any one of Items 1 to 3,
further comprising a sample mark selection reception unit configured to receive a sample mark selection operation of selecting the sample mark superimposedly displayed on the graph from a user,
wherein, when the sample mark selection operation is received by the sample mark selection reception unit, the display control unit further causes the display device to display information regarding a sample corresponding to the sample mark selected by the sample mark selection operation among the plurality of samples.

(Item 5) The atomic absorption spectrophotometer according to Item 5 is the atomic absorption spectrophotometer according to any one of Items 2 to 4,
further comprising a measurement period mark selection reception unit configured to receive a measurement period mark selection operation of selecting the measurement period mark superimposedly displayed on the graph from a user,
wherein, when the measurement period mark selection operation is received, the display control unit further causes the display device to display information regarding a sample corresponding to the measurement period mark selected by the measurement period mark selection operation among the plurality of samples.

(Item 6) The atomic absorption spectrophotometer according to Item 6 is the atomic absorption spectrophotometer according to any one of Items 1 to 5,
further comprising a sample mark selection reception unit configured to receive a sample mark selection operation of selecting the sample mark superimposedly displayed on the graph from a user,
wherein the display control unit further causes a sample table describing information regarding each of the plurality of samples to be displayed on the screen of the display device together with the graph, and when the sample mark selection operation is received by the sample mark selection reception unit, causes the display device to highlight information regarding a sample corresponding to the sample mark selected by the sample mark selection operation among the information of the plurality of samples included in the sample table.

(Item 7) The atomic absorption spectrophotometer according to Item 7 is the atomic absorption spectrophotometer according to any one of Items 2 to 6,
further comprising a measurement period mark selection reception unit configured to receive a measurement period mark selection operation of selecting the measurement period mark superimposedly displayed on the graph from a user,
wherein the display control unit further causes a sample table describing information regarding each of the plurality of samples to be displayed on the screen of the display device together with the graph, and when the measurement period mark selection operation is received by the measurement period mark selection reception unit, causes the display device to highlight information regarding a sample corresponding to the measurement period mark selected by the measurement period mark selection operation among the information of the plurality of samples included in the sample table.

(Item 8) The atomic absorption spectrophotometer according to Item 8 is the atomic absorption spectrophotometer according to any one of Items 1 to 7,
further comprising a second sample mark selection reception unit configured to cause the sample marks attached to the graph to be displayed in a menu format on the display device and receive a second sample mark selection operation of selecting any one from the menu from a user,
wherein the display control unit displays the graph by scrolling in a time direction in a graph display area that is a predetermined area in the screen of the display device, and
when the second sample mark selection operation is received by the second sample mark selection reception unit, causes the graph to scroll in the time direction so that a time at which the sample mark selected by the second sample mark selection reception unit is attached comes to a predetermined position in the graph display area.

(Item 9) The atomic absorption spectrophotometer according to Item 9 is the atomic absorption spectrophotometer according to any one of Items 3 to 8,
further comprising an operation mark selection reception unit configured to cause a list of the operation marks attached to the graph to be displayed on the display device and receive an operation mark selection operation of selecting any one from the menu from a user,
wherein the display control unit displays the graph by scrolling in a time direction in a graph display area that is a predetermined area in the screen of the display device, and
when the operation mark selection operation is received by the operation mark selection reception unit, causes the graph to scroll in the time direction so that a time at which the operation mark selected by the operation mark selection reception unit is attached comes to a predetermined position in the graph display area.

### Reference Signs List

100 . . . Atomization unit
101 . . . Chamber
102 . . . Nebulizer
103 . . . Sample suction tube
104 . . . Fuel gas supply unit
105 . . . Combustion support gas supply unit
106 . . . Flame
107 . . . Burner head
108 . . . Sample container
110 . . . Atomization space
200 . . . Light source unit
301 . . . Spectroscopic unit
302 . . . Photodetector
303 . . . Amplifier
304 . . . A/D converter
400 . . . Control/processing unit
401 . . . Analysis control unit
402 . . . Absorbance calculation unit
403 . . . Absorbance storage unit
404 . . . Real-time graph generation unit
405 . . . Measurement data acquisition unit
406 . . . Measurement data storage unit
407 . . . Sample information storage unit
408 . . . Mark generation unit
409 . . . Display control unit
501 . . . Display unit
502 . . . Operation unit
600 . . . Measurement screen
610 . . . Real-time graph display area
611 . . . Real-time graph
612 . . . Background graph
614 . . . Operation mark
615 . . . Sample mark
616 . . . Measurement period mark
617 . . . Popup screen
618 . . . Pull-down menu
640 . . . Sample table display area
641 . . . Sample table

1. An atomic absorption spectrophotometer comprising:
an absorbance measurement unit configured to measure absorbance by passing measurement light through a predetermined space;
an atomization unit configured to generate atomic vapor derived from a measurement target sample in the predetermined space by heating the measurement target sample;
a sample introduction unit configured to introduce the measurement target sample into the atomization unit; and
a display control unit configured to display, on a screen of a display device in real time,
a graph representing a temporal change in absorbance measured by the absorbance measurement unit over a period from a start to an end of a series of analyses in which each of a plurality of samples is used as the measurement target sample, and to superimposedly display, on the graph, a sample mark that is a mark corresponding to each of the plurality of samples at a position corresponding to a measurement timing of each of the plurality of samples.

2. The atomic absorption spectrophotometer according to claim 1, further comprising a measurement data acquisition unit configured to acquire absorbance measured by the absorbance measurement unit over a predetermined time range after introduction of the measurement target sample into the atomization unit by the sample introduction unit as measurement data for the measurement target sample,
wherein the display control unit further superimposedly displays, on the graph, a measurement period mark that is a mark representing an acquisition period of the measurement data for each of the plurality of samples.

3. The atomic absorption spectrophotometer according to claim 1, further comprising an instruction reception unit configured to receive an instruction from a user,
wherein, when an execution instruction for a predetermined operation is received by the instruction reception unit during a period from the start to the end of the series of analyses,
the display control unit further superimposedly displays, on the graph, an operation mark that is a mark corresponding to the predetermined operation at a position corresponding to an execution timing of the predetermined operation.

4. The atomic absorption spectrophotometer according to claim 1, further comprising a sample mark selection reception unit configured to receive a sample mark selection operation of selecting the sample mark superimposedly displayed on the graph from a user,
wherein, when the sample mark selection operation is received by the sample mark selection reception unit, the display control unit further causes the display device to display information regarding a sample corresponding to the sample mark selected by the sample mark selection operation among the plurality of samples.

5. The atomic absorption spectrophotometer according to claim 2, further comprising a measurement period mark selection reception unit configured to receive a measurement period mark selection operation of selecting the measurement period mark superimposedly displayed on the graph from a user,
wherein, when the measurement period mark selection operation is received, the display control unit further causes the display device to display information regarding a sample corresponding to the measurement period mark selected by the measurement period mark selection operation among the plurality of samples.

6. The atomic absorption spectrophotometer according to claim 1, further comprising a sample mark selection reception unit configured to receive a sample mark selection operation of selecting the sample mark superimposedly displayed on the graph from a user,
wherein the display control unit further causes a sample table describing information regarding each of the plurality of samples to be displayed on the screen of the display device together with the graph, and when the sample mark selection operation is received by the sample mark selection reception unit, causes the display device to highlight information regarding a sample corresponding to the sample mark selected by the sample mark selection operation among the information of the plurality of samples included in the sample table.

7. The atomic absorption spectrophotometer according to claim 2, further comprising a measurement period mark selection reception unit configured to receive a measurement period mark selection operation of selecting the measurement period mark superimposedly displayed on the graph from a user,
wherein the display control unit further causes a sample table describing information regarding each of the plurality of samples to be displayed on the screen of the display device together with the graph, and when the measurement period mark selection operation is received by the measurement period mark selection reception unit, causes the display device to highlight information regarding a sample corresponding to the measurement period mark selected by the measurement period mark selection operation among the information of the plurality of samples included in the sample table.

8. The atomic absorption spectrophotometer according to claim 1, further comprising a second sample mark selection reception unit configured to cause the sample marks attached to the graph to be displayed in a menu format on the display device and receive a second sample mark selection operation of selecting any one from the menu from a user,
wherein the display control unit displays the graph by scrolling in a time direction in a graph display area that is a predetermined area in the screen of the display device, and
when the second sample mark selection operation is received by the second sample mark selection reception unit, causes the graph to scroll in the time direction so that a time at which the sample mark selected by the second sample mark selection reception unit is attached comes to a predetermined position in the graph display area.

9. The atomic absorption spectrophotometer according to claim 3, further comprising an operation mark selection reception unit configured to cause a list of the operation marks attached to the graph to be displayed on the display device and receive an operation mark selection operation of selecting any one from the menu from a user,
wherein the display control unit displays the graph by scrolling in a time direction in a graph display area that is a predetermined area in the screen of the display device, and
when the operation mark selection operation is received by the operation mark selection reception unit, causes the graph to scroll in the time direction so that a time at which the operation mark selected by the operation mark selection reception unit is attached comes to a predetermined position in the graph display area.
